(19) United States
(12) Patent Application Publication
(10) Pub. No.: US 2011/0304143 A1
(43) Pub. Date: Dec. 15, 2011

(54) WIND GENERATOR FOR INSTALLATION ON A HOUSE

(76) Inventor: Jim Nguyen, Jefferson City, MO (US)

(21) Appl. No.: 12/814,983

(22) Filed: Jun. 14, 2010

(51) Int. Cl. F03D 9/00; F03B 13/00; F03D 11/00

(52) U.S. Cl. 290/52; 290/55; 290/54

(57) ABSTRACT

Apparatus (10) for generating electricity comprises a plurality of wind turbines (20) each of which has a rotatable shaft (12) on which a rotor assembly (22) is mounted for turning about a magnet assembly (26). The shaft is coupled to a housing (16) which is rotated in response to wind flow to produce shaft rotation. A second mechanism (30) also produces shaft rotation in response to wind flow, whereby the wind turbine generates electricity in response to wind flow. While each wind turbine has its own shaft, housing, and coupling, the second mechanism is commonly connected to all the wind turbines. A third mechanism (60) is also provided for producing shaft rotation. Each wind turbine includes its own third mechanism. Other embodiments of the invention include a hybrid turbine (100) which utilizes both air and water to produce shaft rotation, and a submerged turbine (300).

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to a wind turbine or wind generator for producing electricity; and, more particularly, to a generator for installation on the roof of a house or other small structure.

Wind turbines or wind generators are known in the art. The typical wind generator comprises a multi-bladed propeller mounted atop a pole and the structure is often referred to as a windmill generator. The propeller rotates in response to wind currents and rotation of a shaft on which the propellers are mounted turn the rotor of an electrical generator and produce electricity. Although many such generators are located on wind farms so a large number of units located in close proximity to each other in a grid produce large amounts of electricity, individual units have been installed adjacent a facility to produce electricity used by the facility.

Anyone who has seen a windmill generator knows that even smaller units are quite tall, this being so in order for the propeller assembly to be able to catch wind currents. As such, while these units are well suited for installations in industrial parks or the grounds of a factory or manufacturing facility, they are impractical for use for on a home site or small business facility. Separate and apart from any aesthetics associated with installing a tall structure next to a house, for example, the cost to erect and maintain such a unit is probably prohibitive for most home owners and small business people.

Nonetheless, the ability to generate and store electricity for one's own use has a great amount of appeal. Energy costs are increasing. Accordingly, a small, efficient energy generating capability, that also has the advantage of not being an “eyesore” and therefore acceptable for home or small business installation is advantageous.

Further, in many rural, remote, or undeveloped areas, a constant supply of electricity is unavailable. In these areas gasoline powered generators or the like are used. Using them, however, requires that gasoline be shipped into the area in sufficient quantities to run the generator on a continuous basis. This is both expensive and requires a large amount of storage space.

### BRIEF SUMMARY OF THE INVENTION

The present invention is directed to a wind turbine/generator for installation on the roof of a house or other, typically small, business facility. The turbine is responsive to the flow of wind to generate electricity used in the house or facility in lieu of electricity delivered to the house or facility from a power grid operated by an electrical utility. This makes the home owner or business owner less dependent on the utility to supply his electrical energy needs. Conversely, the turbine diminishes the demand on the utility which makes it easier for the utility to supply the power requirements of its customers, particularly during times of peak energy demand.

The turbine comprises an assembly including a primary wind source and one or more secondary wind sources which are used to rotate a shaft on which elements of the turbine are installed. This improves the efficiency of the turbine to produce electricity. An advantage of the secondary wind sources is that they maintain shaft rotation, so the turbine produces electricity, even if the shaft is decoupled from the primary wind source during excessive wind speed conditions. This wind sources comprise housings mounted on the roof of a structure and rotatable with the wind to catch as much of the wind as possible and use it to produce shaft rotation.

The turbine further employs a series of magnets spaced about the turbine with the position of the magnets being controlled by the force of the wind. In addition, relatively cool air is directed through the magnets onto the turbine assembly to reduce the heat load produced by the turbine and further improve its efficiency.

Electricity produced by the turbine is stored on-site in a battery, capacitor bank, or the like. When the stored energy is used, it is converted to 120 VAC, 60 Hz energy which is used to power household appliances, and equipment used in businesses, stores, and manufacturing facilities. Importantly, the wind turbine is a self-contained, stand alone system that is not affected by power outages in conventional power distribution systems which may result from storms, system overloads (blackouts or brownouts), earthquakes and the like.

Depending on the facilities, two or more generators can be arranged in rows or in-line. The generators are not only useful to supplement electricity supplied by a utility. In rural, remote, or undeveloped areas, the wind turbine provides a cheap, relatively constant source of electricity.

A hybrid turbine construction is also described in which the primary source for rotation the turbine shaft to produce electricity is wind driven, but at least one of the secondary sources utilizes water to provide shaft rotation.

A third turbine construction is also described in which the turbine is submerged in water.

Other objects will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a plan view of the roof of a house with air inlet housings installed on a building with a peaked roof;

FIG. 2 is plan view similar to FIG. 1 for a building with a flat roof;

FIG. 3 is a block diagram representation of use of the wind turbine to supplement electricity supplied by a utility;

FIG. 4 is a simplified representation of a first embodiment of a wind turbine of the present invention;

FIG. 5 is a partial view of a magnet assembly of the wind turbine;

FIG. 6 is an end view of the magnet;

FIG. 7 is a simplified representation of a second embodiment of the wind turbine;

FIG. 8 is an elevation view of a simplified representation of a third embodiment of the turbine; and,

FIG. 9 is a plan view thereof.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, a wind turbine or wind generator apparatus of the present invention is indicated generally 10 in the drawings. The wind turbine is designed and constructed for installation in a house H, or small business or commercial structure. In use, turbine/generator 10 generates electricity used to heat and cool the building, illuminate the building, and power appliances and machinery installed within the building or facility. As such, the generator supplements power supplied by an electrical utility U to the structure, or from other alternate power sources (e.g., solar panels) not shown. Power supplied by whatever source is routed through the house from a circuit breaker panel P such as is typically located in a basement or utility room of the house. Electricity flow to the circuit breaker panel is through a relay R. That is, if generator or generators 10 can furnish an adequate amount of power to supply the electrical needs of the house, relay R is switched so to draw power from the generator(s). In this configuration, electrical energy produced by the generator(s) is supplied to a converted C which supplies 120 VAC, 60 Hz energy through relay R to panel P. When the generator is unable to supply adequate power, the relay is operated so that a portion (or all) of the electrical energy needs which cannot be supplied by generator 10 are drawn from utility U. At this time, the electrical energy produced by the generator(s) is supplied to a storage unit S which is, for example, a storage battery or capacitor bank. Importantly, to the extent generator(s) 10 of the present invention can supply the electrical needs of the building or facility there is no need to draw power from utility U. This can then significantly reduce the electrical bill of the home owner or business owner.

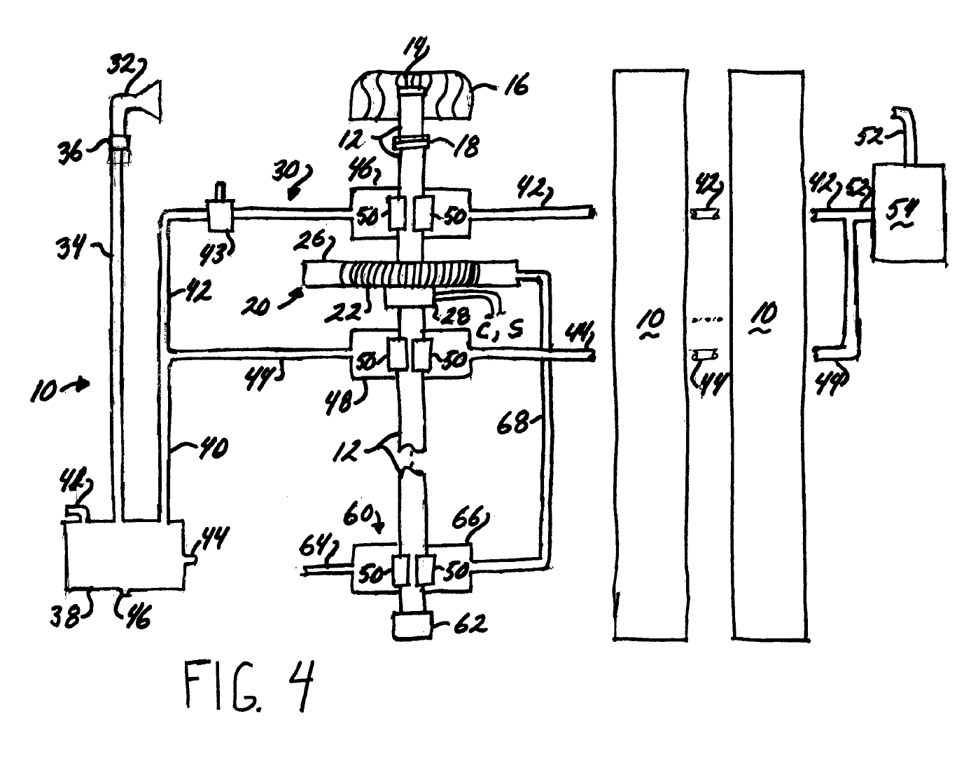

The present invention includes one or a plurality of wind turbines 10. As shown in FIGS. 3 and 4, and as described hereinafter, the turbines are arranged and connected in tandem. Referring to FIG. 4, a turbine shaft 12 is coupled, as indicated at 14 to a housing 16 which is installed on the roof of a building. The housing is designed to catch the wind and rotate or turn as the wind blows on the housing. Since shaft 12 is connected to the housing, rotation of the housing causes rotation of shaft 12.

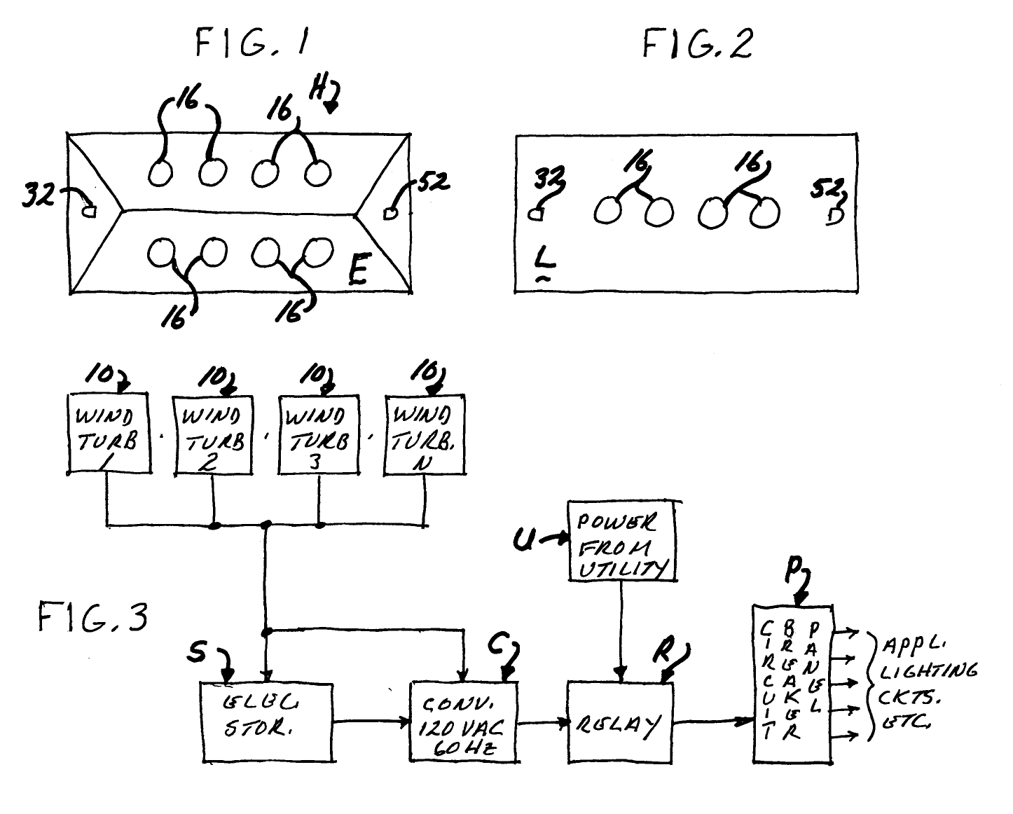

As shown in FIG. 1, for a house H having a peaked a peaked roof F, eight wind turbines have shafts connected to housings 16, the housings being arranged in two rows of four, each row being on one side of the roof. This arrangement enables the housings to catch the wind regardless of the direction from which the wind is blowing. For a flat roof L shown in FIG. 2, the housing can be arranged in a single row. Regardless of the housing arrangement, the force of the wind on the housing causes the housing to rotate turning the shaft 12 connected to the housing. Each turbine 10 further includes a coupling 18 connecting an upper section of shaft 12 connected to the housing, and a lower section of the shaft. While wind turbine 10 is designed to operate over a wide range of wind speeds, if the wind speed becomes so strong that damage may occur to either the shaft or the housing, coupling 18 disconnects the upper section of the shaft from the housing so to prevent damage to the shaft. When the wind speed abates to an acceptable level, coupling 18 reconnects the two sections of the shaft.

The electrical generator portion of wind turbine 10 is indicated generally 20 and includes a wire wound rotor 22 mounted on shaft 12. As is known in the art, rotation of shaft 12 causes rotor 22 to rotate through an electromagnetic field established in conjunction with magnets 24 housed in an assembly 26. The resulting electric current is drawn off to converter C or storage unit S through a slip ring assembly 28. Those skilled in the art will understand that the elements comprising electrical generator portion 20 of wind turbine 10 are representative only, and that other rotor, magnet assemblies, and slip ring assemblies may be used without departing from the scope of the invention.

It is a feature of the present invention, that in addition to rotation of shaft 12 being produced by rotation of housing 16 by the wind, a second source of shaft 12 rotation is produced by a secondary air flow assembly indicated generally 30. Assembly 30 first includes an air inlet 32 installed on the roof of the building. Air is drawn into secondary air flow assembly 30 when inlet 32 is open. Inlet 32 is connected to an inlet tube 34 through a coupling 36 which allows the inlet to rotate with the wind so to be in the direction in which the wind is blowing. Air flowing through tube 34 enters into a chamber 38 and exits from the chamber through an outlet tube 40. Chamber 38 is, for example, located in the basement of the building where the temperature may be cooler than at inlet 32. Chamber 38 further has a water inlet 41 which, when open, allows water to flow through the chamber and to an outlet port 44 which is connected to a trap (not shown). Inlet 41 is controlled so to control the water level in chamber 38. A drain 46 is in the bottom of the chamber for draining water from the chamber. Chamber 38 is used to collect dust, leaf material, and other debris carried by the air, so that these particles due not damage shaft 12. Since these particles are heavier than air, then as the air flows through chamber 38 so are picked up by the water flowing through the chamber and carried away.

Air from chamber 38 flowing through tube 40 is now directed at shaft 12 Tube 40 splits into two tubes 42 and 44. Tube 42 empties into a chamber 46 which encloses shaft 12 at a location above generation portion 20 of the wind turbine assembly. At the same time, tube 44 empties into a chamber 48 which encloses shaft 12 at a location below the generation portion of the wind turbine assembly. Interposed in tube 42 is a temperature controlled air flow valve 43 which, when open, allows air such as the air circulating in the attic of a house or crawl space of a building to be drawn into the air flow passage and contribute to the amount of air flowing over the blades 50 in chamber 46.

Fan blades 50 extend outwardly from shaft 12 at the portions of the shaft extending through chambers 46 and 48. Accordingly, the air flow through the chambers across these fan blades causes the blades to further produce a rotation of shaft 12. At the outlet side of chambers 46 and 48, the air again flows through the respective tubes 42 and 44 until it enters the respective chambers 46 and 48 for the next wind turbine. After the air has flowed through the chambers 46 and 48 for the last wind turbine, the tubes 42 and 44 are connected together at the inlet of an outlet tube 52. A low speed fan blower or motor 54 is interposed in outlet tube 52. Although only one motor 54 is shown in FIG. 4, those skilled in the art will understand that there can be more than one motor used in the system. For example, a motor 54 may be installed between each wind turbine 10. When the wind speed is very low, this unit is energized to draw air into secondary air flow assembly 30. This results in sufficient air flow to keep the shafts 12 of each wind turbine turning so that even if the shaft speed is so low that no appreciable amount of electrical energy is produced, the shaft rotation is such that when the wind velocity increases to the point where rotation of housing 16 is sufficient to rotate the shaft, there is little or no shaft inertia which must be overcome for the shafts to turn at a sufficient speed that electricity is generated by the wind turbine. Importantly, assembly 30 is effective to rotate shaft 12 even when the shaft is decoupled from housing 16 as previously described. Thus, wind turbine 10 is still capable of generating electricity, even in extremely high wind conditions.

In addition to secondary air flow assembly 30, a tertiary air flow assembly 60 is provided. Assembly 60 is located at the bottom end of shaft 12 adjacent the bottom end cap and bearing 62 in which the lower end of the shaft is journaled. Air circulation through the house or basement of the house enters an inlet tube 64 and flows through a chamber 66 enclosing fan blades 50 mounted at the lower end of the shaft. Again the flow of air over the blades produces a rotation of the shaft. From chamber 66, the air flows into an outlet tube 68.

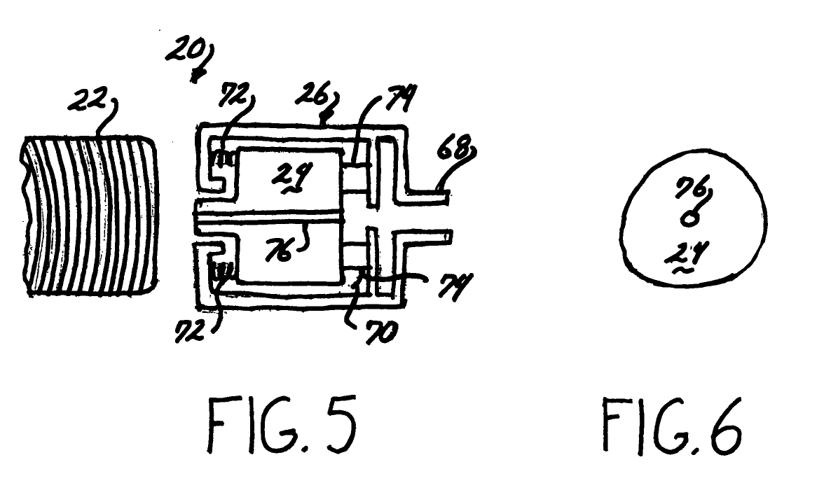

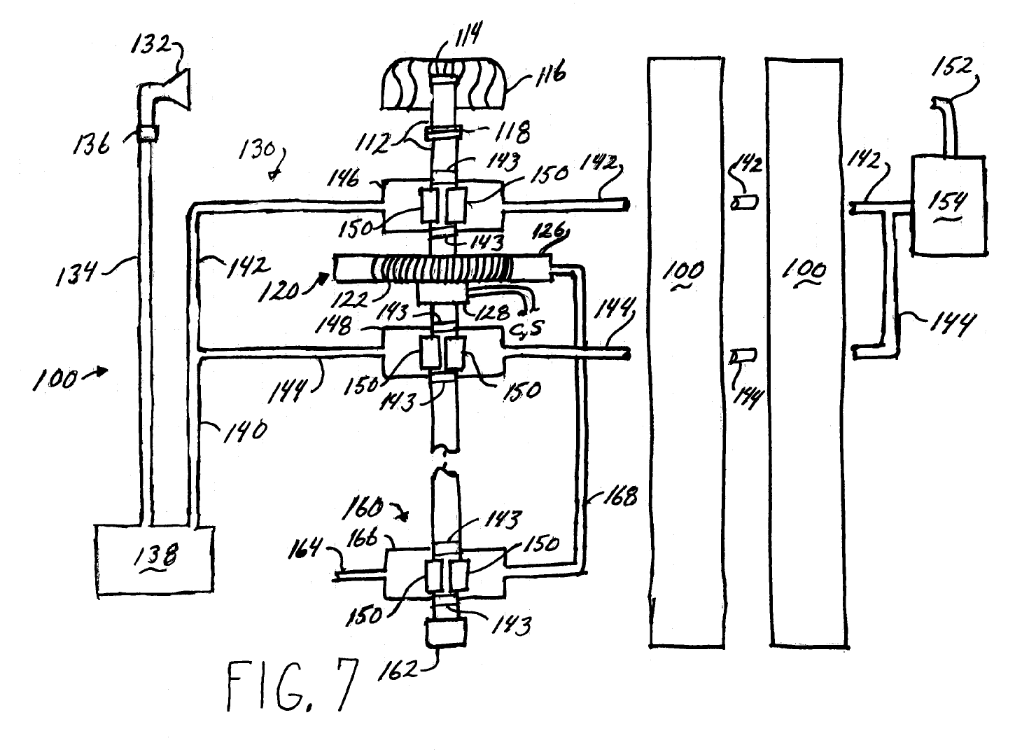

Referring to FIG. 5, the air flowing through tube 68, which is relatively cool air, flows into an inlet of magnet assembly 26 and about the assembly. As shown in FIG. 5, each magnet 24 is mounted in a housing 70 so as to be positioned close to the outer margin of rotor 22. The position of each magnet within its housing is controlled by springs 72 and fixed magnets 74 which support magnet 24 against the rear wall of the housing. Each magnet has a longitudinal central bore 76. Air entering magnet assembly 26 is drawn through the bore 76 in each magnet by the force created by the rotation of rotor 24 about the magnet assembly. Since, as noted, this air is relatively cool air, it supplies cooling to the generator assembly, helping prevent overheating of the assembly.

It will be noted that there is a separate tertiary air flow assembly 60 for each wind turbine.

What has been described is a wind turbine assembly comprising one or more wind turbines each of which has more than one air flow mechanism so to produce rotation of a shaft 12 of the assembly and the production of electricity. The number of turbines used is a function of the electricity needs of the house or commercial establishment. In areas where little electricity may be required, a single wind turbine may be adequate to supply the electrical needs. However, regardless of how many wind turbines are required, the wind turbine assembly of the present invention provides a reliable means of supplying it.

Referring now to FIG. 7, a second embodiment of the wind turbine is indicated generally 100. Each turbine 100 includes a coupling 118 connecting an upper section of a shaft 112 connected to a housing 116, and a lower section of the shaft. As with the previously described embodiment, if the wind speed becomes so strong that damage may occur to either the shaft or the housing, coupling 118 disconnects the upper section of the shaft from the housing to prevent damage to the shaft. Again, when the wind speed abates coupling 118 reconnects the two sections of the shaft.

The electrical generator portion of wind turbine 100 is indicated generally 120 and includes a wire wound rotor 122 mounted on shaft 112 to rotate through an electromagnetic field established in conjunction with magnets housed in an assembly 126. The electric current is drawn off to converter C or storage unit S through a slip ring assembly 128. Again those skilled in the art will understand that the elements comprising electrical generator portion 120 of the turbine are representative only and that other rotor, magnet, and slip ring assemblies can be used without departing from the scope of the invention.

The electrical generator portion of wind turbine 100 is indicated generally 120 and includes a wire wound rotor 122 mounted on shaft 112 to rotate through an electromagnetic field established in conjunction with magnets housed in an assembly 126. The electric current is drawn off to converter C or storage unit S through a slip ring assembly 128. Again, those skilled in the art will understand that the elements comprising electrical generator portion 120 of wind turbine 100 are representative only, and that other rotor, magnet assemblies, and slip ring assemblies may be used without departing from the scope of the invention.

In addition to rotation of shaft 112 being produced by the wind rotating housing 116, a second source of shaft 112 rotation is produced by a secondary assembly indicated generally 130 into which water is drawn. Now, water flow through assembly 130 produces shaft 112 rotation. Assembly 130 includes a water inlet 132 conveniently located to a water source. This could be a pond, lake, river, or ocean. Inlet 132 is connected to an inlet tube 134 through a coupling 136. Water flowing through tube 134 enters a water filter 138 and is drawn from the filter through an outlet tube 140. Filter 138 removes debris and other material which may cause damage to turbine 100.

Water from filter 138 flowing through tube 140 is now directed at shaft 112. Tube 140 splits into two tubes 142 and 144. Tube 142 directs water through a chamber 146 which encloses shaft 112 at a location above generation portion 120 of the turbine assembly. At the same time, tube 144 directs water through a chamber 148 which encloses shaft 112 at a location below the generation portion of the wind turbine assembly. Respective seals 143 fitted about shaft 112 prevent water flowing through the respective chambers to leak onto the shaft.

Fan blades 150 extend outwardly from shaft 112 at the portions of the shaft extending through chambers 146 and 148. Accordingly, water flow through the chambers across these fan blades causes the blades to produce rotation of shaft 112. At the outlet side of chambers 146 and 148, the water again flows through the respective tubes 142 and 144 until it enters the respective chambers 146 and 148 for the next wind turbine. After the water has flowed through the chambers 146 and 148 for the last wind turbine, the tubes 142 and 144 are connected together at the inlet of an outlet tube 152. A water pump 154 is interposed in outlet tube 152 to draw water through assembly 130. This water pump produces sufficient water flow through assembly 130 to keep the shafts 112 of each wind turbine 100 turning; again, so that even if the shaft speed is so low that no appreciable amount of electrical energy is produced, the shaft rotation is such that when the wind velocity increases to the point where rotation of housing 116 is sufficient to rotate the shaft, there is little or no shaft inertia which must be overcome for the shafts to turn at a sufficient speed that electricity is generated by the wind turbine. Also, assembly 130 is effective to rotate shaft 112 even when the shaft is decoupled from housing 116 as described above. Thus, turbine 100 is still capable of generating electricity, even in extremely high wind conditions.

In addition to secondary air flow assembly 130, a tertiary air flow assembly 160 is provided. The construction and operation of assembly 160 is similar to that of assembly 60 of the first described embodiment of the invention and will not be described in detail. The assembly again is located at the bottom of shaft 112 adjacent a bottom end cap and bearing 162 in which the lower end of shaft 112 is journaled. Air enters an inlet tube 164 and flows through a chamber 166 enclosing fan blades 150 mounted at the lower end of the shaft with the air flow over the blades produces a rotation of the shaft. From chamber 166, the air flows into an outlet tube 168 and to an inlet of magnet assembly 126 for cooling purposes as previously described.

It will appreciated by those skilled in the art that apparatus 100 is a hybrid apparatus in that it generates electricity in response to air flow, wind flow, or both. That is, if the wind flow is sufficient to turn shaft 112 to produce a desired amount of electricity, there may need to be no water flow through secondary assembly 130. On the contrary, if there is insufficient wind flow, water flow through the secondary assembly may be sufficient to effect rotation of shaft 112 so to generate the desired amount of electricity. In certain instances, air flow and water may both be used so the turbine generates the requisite amount of electricity.

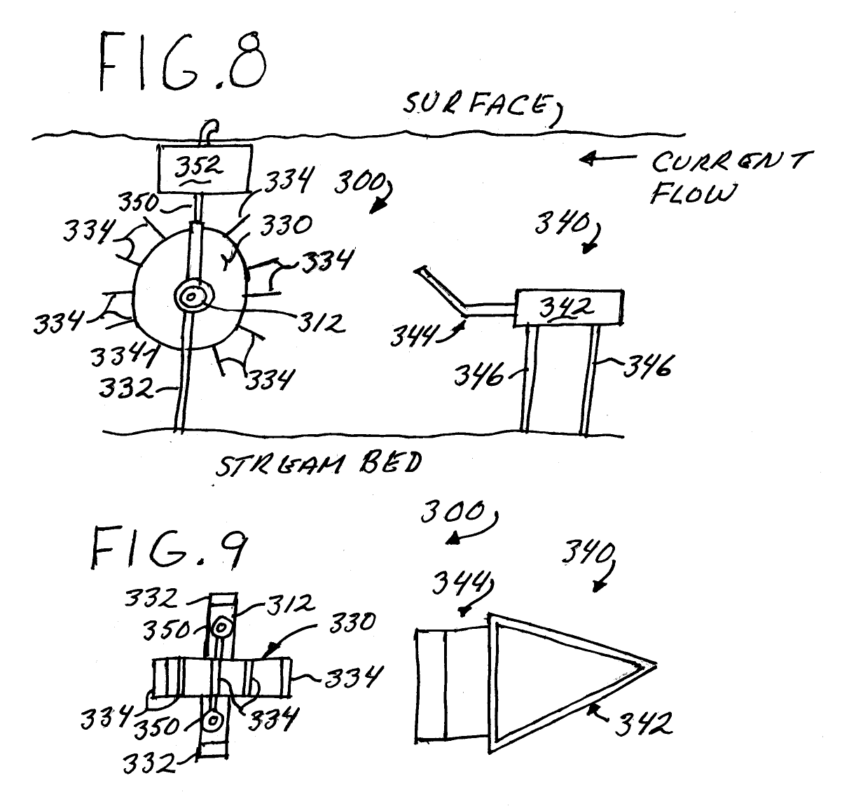

Referring to FIGS. 8 and 9, a turbine 300 is a submerged assembly located in the path of a stream or the like for water to flow over the turbine. The electrical generator portion of turbine 300 is indicated generally 320 and includes a wire wound rotor assembly rotatably installed within a housing 330 mounted on shaft 312 to rotate through an electromagnetic field established in conjunction with magnets housed in a fixed assembly (not shown) Installed within the housing. Electric current is drawn off to converter C or storage unit S through a slip ring assembly installed within the housing. Housing 330 is a sealed, water tight housing. The outer ends of shaft 312 are journaled for rotation on respective posts 332. The bottoms of the posts are set in the bed of the water course to support the turbine above the bed of the stream, but some distance below the top of the stream. The height of the posts is adjustable to adjust the position of turbine 300 so the turbine can be fully submerged as shown in FIG. 8, or only partially submerged. For example, the height of the poles is adjustable so up to one-third (⅓) of the turbine assembly is above the surface of the water. Paddles 334 are hingedly mounted on the outside of housing 330 (for example, by welding) perpendicular to the direction of water flow so that the housing assembly has a paddle wheel configuration. The paddles automatically open and close as water flows past housing 330 thus for the rotor assembly to rotate in response to water pushing against the paddles 334 and turning housing 330 as the water flows past the turbine.

A deflector assembly 340 is installed upstream of housing 330. The deflector assembly includes a V-shaped deflector section 342 which directs material flowing in the water around the sides of housing 330 so the housing is not damaged by debris, etc. in the stream. An upwardly angled flap 344 is installed behind the deflector to direct water flow up and over housing 330. The deflector assembly is mounted on posts 346 the bottoms of which are set in the bed of the stream.

Finally, reciprocal air intakes 350 are installed about housing 330. These intakes draw air into the housing through a chamber 352 located at the surface of the water. Air drawn in through the intakes is directed to the magnet assembly within housing 330 for the same reasons as discussed with regard to the first embodiment of the invention.

In view of the above, it will be seen that the several objects and advantages of the present disclosure have been achieved and other advantageous results have been obtained.

Having thus described the invention, what is claimed and desired to be secured by Letters Patent is:

1. Apparatus (10) for generating electricity comprising:
at least one wind turbine (20) having a rotatable shaft (12) on which a rotor assembly (22) is mounted;
first means (14, 16) for producing rotation of the shaft in response to wind flow; and,
a second means (30) for also producing shaft rotation in response to wind flow, whereby the wind turbine generates electricity in response to wind flow.

2. The apparatus of claim 1 further including a plurality of wind turbines, each wind turbine including a shaft on which a rotor assembly is mounted, each wind turbine including a said first means for producing rotation of its shaft in response to wind flow, and with said second means for producing shaft rotation in response to wind flow being common to all the wind turbines.

3. The apparatus of claim 2 further including a third means (60) for producing shaft rotation, each wind turbine including a separate said third means.

4. The apparatus of claim 1 including a housing (16) exposed to the wind to rotate in response to wind striking the housing, and a coupling (14) for coupling one end of the shaft to the housing for the shaft to rotate in response to rotation of the housing.

5. The apparatus of claim 4 further including a decoupler (18) for disconnecting the shaft from the housing if the wind force becomes excessive thereby to protect the wind turbine from damage.

6. The apparatus of claim 1 in which the second means for producing shaft rotation includes an air inlet (32) and an air outlet (52) and air flow passages (34, 40, 42, 44) by which air is drawn through second means past each wind turbine to produce rotation of the shaft of each wind turbine.

7. The apparatus of claim 6 further including a first set of fan blades (50) mounted on the shaft at a location above the rotor assembly and a second set of fan blades (50) mounted on the shaft at a location below the rotor assembly, and the second means for producing shaft rotation includes one air passage (42, 46) for flowing air over the first set of fan blades and a second air passage (44, 48) for flowing air over the second set of fan blades, flow of air over the respective sets of fan blades producing rotation of the shaft.

8. The apparatus of claim 7 wherein each wind turbine has a first and second set of fan blades mounted on its respective shaft with the first said and second air flow passages respectively directing air over the respective sets of fan blades to produce rotation of the shaft of each wind turbine.

9. The apparatus of claim 6 including means (38, 41, 44, 46) for removing dust, leaf material, and other debris carried by the air from the air, so that these particles due not damage the shaft of a wind turbine.

10. The apparatus of claim 3 in which each wind turbine includes a magnet assembly (26) about which the rotor assembly is rotated by the shaft to generate electricity, the magnet assembly including a plurality of magnets (24) and means (72, 74) for locating the magnets in proximity to the rotor assembly.

11. The apparatus of claim 10 in which the third means for producing shaft rotation further provides relatively cool air to the magnet assembly.

12. The apparatus of claim 11 further including a third set of fan blades located at a lower end of the shaft for air flowing over the third set of fan blades to produce rotation of the shaft, the air further being directed to an air inlet (68) of the magnet assembly.

13. The apparatus of claim 12 in which each magnet in the magnet assembly has a longitudinal bore (76) extending therethrough for air entering the magnet assembly to be drawn through each magnet by the rotation of the rotor assembly, the air acting to cool the assembly.

14. The apparatus of claim 1 in which the electricity produced is supplied to a conversion means (CC) which converts the electricity to an amplitude and frequency required to operate appliances, lights and other electricity users.

15. The apparatus of claim 14 in which the electricity is supplied to a storage means (S) for subsequent use.

16. The apparatus of claim 8 further including a low speed fan blower (54) interposed in an outlet passage (52) of said second means, said blower being energized when the wind speed is low so to draw air into said second means thereby to provide sufficient air flow to keep the shaft of each wind turbine turning so that even it the shaft speed is so low that no appreciable amount of electrical energy is produced, there is still little or no shaft inertia which must be overcome for the shafts to start rotation when the wind velocity increases to a sufficient speed that electricity is generated by the wind turbine

17. The apparatus of claim 1 in which water rather than air flows through the second means (30) to produce shaft rotation in response to the water flow, whereby the wind turbine generates electricity in response to both wind flow and water flow.

18. Apparatus (100) for generating electricity comprising:
at least one turbine (120) having a rotatable shaft (112) on which a rotor assembly (122) is mounted;
first means (114, 116) for producing rotation of the shaft in response to wind flow; and,
a second means (130) for producing shaft rotation in response to water flow rather than wind flow, whereby the apparatus is a hybrid apparatus for generating electricity in response to wind flow, water flow, or both.

19. The apparatus of claim 18 further including a third means (160) for producing shaft rotation, each wind turbine including a separate said third means.

20. The apparatus of claim 18 further including a water pump (154) interposed in an outlet passage (152) of said second means, said water pump drawing water through said second means at a flow rate sufficient to keep the shaft of each wind turbine turning.

21. Apparatus (300) for generating electricity comprising:
a housing (330) in which is installed a rotor assembly and a magnet assembly, the housing being a sealed, water tight housing located below the surface of flowing water;
paddles (334) installed on the outside of the housing for turning the housing in response to water striking the paddles as it flows past the assembly; and,
means (350, 352) for directing air from the atmosphere to the magnet assembly for the air to be drawn into a bore of the rotor assembly to facilitate the generation of electricity.

22. The assembly of claim 21 further including a deflector means (340) located upstream of the housing to deflect debris in the water around the housing and prevent damage to it.

23. The apparatus of claim 21 further including posts (332) on which the housing is supported, the height of the posts being adjustable so to raise the housing partially above the surface of the water.
